(19) United States
(12) Patent Application Publication
(10) Pub. No.: US 2010/0224684 A1
(43) Pub. Date: Sep. 9, 2010

(54) SMART CARD READER

(75) Inventors: Frederick Bonnin, Trets (FR); Sebastien Faivre, Aix En Provence (FR); Ahmed Ould Elhacen, Aix En Provence (FR)

Correspondence Address: SCHWEGMAN, LUNDBERG & WOESSNER / ATMEL, P.O. BOX 2938, MINNEAPOLIS, MN, 55402, US

(73) Assignee: Atmel Corporation, San Jose, CA (US)

(21) Appl. No.: 12/397,029

(22) Filed: Mar. 3, 2009

(51) Int. Cl. G06K 7/06

(52) U.S. Cl. 235/441

(57) ABSTRACT

A card reader receives an indication that a device has been plugged into a socket of the card reader. Power is provided to the socket in accordance with a first type of device. An attempt to communicate with the device is made in accordance with a first type of device protocol. If the communication attempt is not successful, power is provided to the socket in accordance with a second type of device, and communications commence with the device in accordance with a second type of device protocol.

### BACKGROUND

Many smart card reader accept different types of cards, and have a host controller, such as a PC (personal computer) recognize the type of card, such as USB (universal serial bus) device plugged to it through a USB hub. The card reader acts as a USB hub or ‘bridge’ that will forward requests from the card to the host. In a manner, the card will enumerate to the PC.

### BRIEF DESCRIPTION OF THE DRAWINGS

FIG. 1 is a block diagram of a smart card reader according to an example embodiment.

FIG. 2 is a flow chart illustrating a method of interfacing with cards plugged into a socket of the smart card reader according to an example embodiment.

FIG. 3 is a timing diagram illustrating signals used in detecting a first type of card according to an example embodiment,

FIG. 4 is a timing diagram illustrating signals used in detecting a second type of card according to an example embodiment.

FIG. 5 is a block diagram of an example computer system having a smart card reader according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A smart card reader recognizes a card type and initializes communication with a card without interrupting a host system. In one embodiment, a USB (universal serial bus) card is not recognized as USB peripheral to the host. The host will see the smart card reader, with a card. But it won't change the way it works if the card is one of several different types, such as a UART7816 or USB card. The card in essence enumerates to the smart card reader. The smart card reader will then inform the host that a smart card has been detected.

Software knowledge to interact with different cards may be embedded in the smart card reader in various embodiments. Host controller drivers do not need to be changed or modified. The controller driver or drivers may just communicate directly with the smart card reader. The smart card reader is responsible for handling communications using UART7816 or USB protocols in one embodiment, or other protocols for still different types of cards.

In one embodiment, the behavior of applications need not change when a different type of card is inserted in the smart card reader. Requests from such cards may be addressed to the smart card reader. With prior card readers, the host application needed to communicate to a smart card reader (if UART8916 card is detected), or to a USB Device (if a USB smart card is detected). Twice as many drivers needed to be supported along with dual command sets to be maintained.

Many applications running on a host using smart card reader capabilities do not have knowledge of smart card protocols. Such applications access a high level API (application programming interface) for communication, cryptography or data collection. Since in various embodiments, smart card knowledge resides in the smart card reader, such applications do not need to have the knowledge.

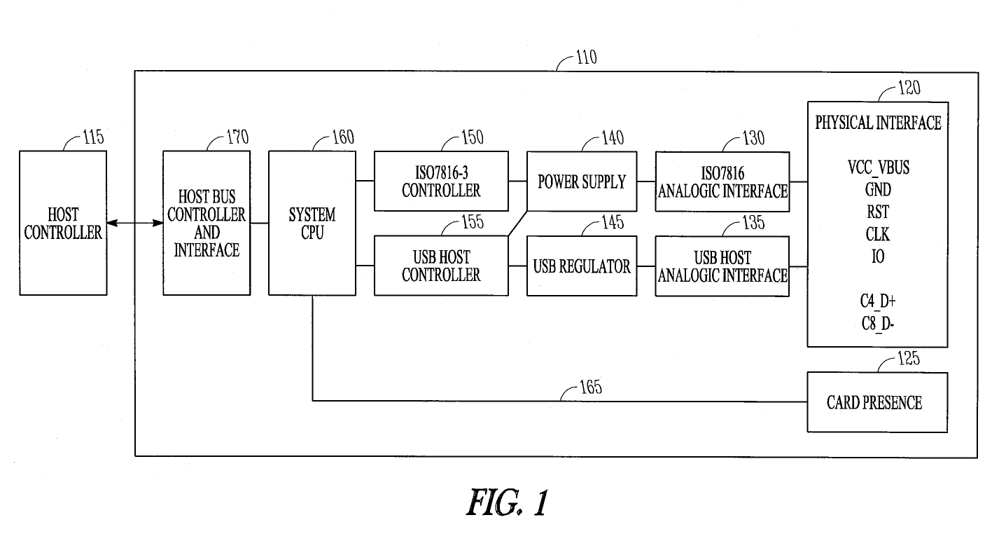

FIG. 1 is a block diagram of a smart card reader 110 coupled to a host 115. Smart card reader 110 has a physical interface 120 into which multiple cards may be connected, such as by plugging in. The physical interface 120 in one embodiment comprises multiple pins in a socket that couple with matting pins on cards when the cards are plugged into the socket. Pins may be provided for various signals, such as Vcc_VBUS, Gnd (ground), Rst (reset), Clk (clock), IO (input/output for UART7816 smart cards) and C4_D+, C8_D−. The D+ and D− pins are used for USB signals, which are differential signals. The use of differential signals provides for much faster logical transitions and hence a higher throughput than some other communication protocols, such as those used for UART7816 smart cards. In one embodiment, the physical interface includes a card presence pin 125.

In one embodiment, each of the different types of cards may utilize different voltages to connect to the card reader 110 via the physical interface 120. For instance, UART7816 smart cards may utilize a first level of voltage (1.8V, 3 or 5V corresponding to different classes of cards), while USB cards may utilize a positive voltage of 3.3V. A first logic interface 130 is coupled to physical interface 120 to convert smart card 110 voltages to the level needed at the physical interface for UART7816 smart cards. A second logic interface 135 is also coupled to physical interface 120 to convert smart card 110 voltage levels to levels utilized in USB cards, and in particular to the D+ and D− pins.

A power supply 140 is coupled to the first logic interface 130 to provide the appropriate power levels for the Vcc_VBUS pin. A USB regulator 145 is coupled to the second logic interface 135, and provides the differential voltages for communications. A first controller 150 is coupled to the power supply, and is first used to attempt to communicate with a first type of card plugged into the socket of physical interface 120. If not successful, a second controller 155 is used to attempt to communicate with a second type of card plugged into the socket of physical interface 120. Further types of cards may be used in further embodiments, each sequentially tested to determine the nature of the corresponding card and the appropriate means of communicating with it. In one embodiment, host controller 115 is not involved in the determination of the type of card plugged into the socket of physical interface 120, and may treat different types of such cards identically via smart card reader 110.

In one embodiment, a system processor 160, such as a CPU (central processor unit) is a microprocessor or microcontroller that controls establishing communications with plugged in cards. When a card is plugged in to the socket of physical interface 120, the card presence pin is activated, such as by shorting it to ground. In further embodiments, the detection may alternatively be done by shorting the-pin to a predetermined voltage, such as Vcc. This may be configurable via first controller 150). Such activation is detected via a line 165 which is coupled to processor 160. An interrupt is generated, the processor 160 begins to establish the type of card connected, and how to communicate with such card. Once such communication is established, a common interface to the card is provided to host controller 115 via a host bus controller and interface 170.

In an alternative embodiment, the card reader includes a physical interface having a card presence connector. The logic interfaces may be combined into one logic interface that is coupled to the physical interface. A regulator is coupled to the logic interface, and a single controller is coupled to the regulator and to the card presence connector to determine whether a first type of card is coupled to the physical interface and if not, to determine whether a second type of card is coupled to the physical interface.

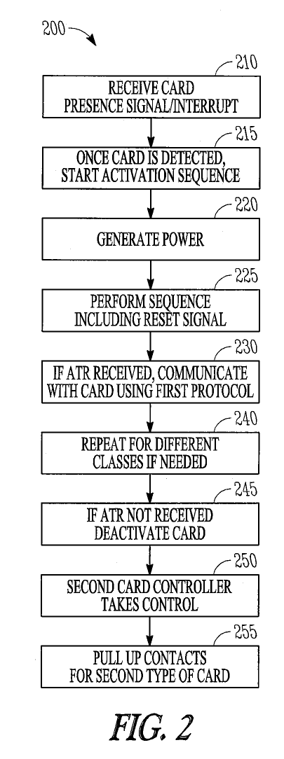

A method utilizing the smart card reader 110 is shown generally at 200 in FIG. 2. At 210, when a card is plugged into the socket of the physical interface 120, a card presence signal is generated via card presence pin 125. The card presence signal is an input, such as an interrupt, and is received by the processor 160 from the smart card socket. Once the smart card insertion is detected, the system proceeds to activation sequence at 215, as described in ISO7816 norm, where the first type of card is a UART7816 smart card.

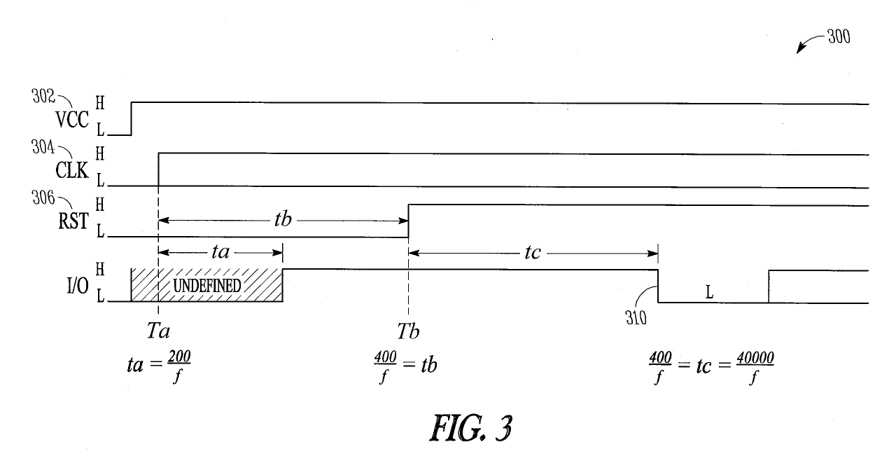

The activation sequence causes the first controller 150, an ISO7816-3 controller in one embodiment to cause the power supply 140 to generate power at 220. An ISO sequence is then performed at 225. The Vcc, Clk, Rst lines 302, 304 and 306 respectively are generated by physical interface 120, as shown in a timing diagram 300 in FIG. 3. Vcc 302 is first provided, followed by the Clk 304 signal and the Rst 306 signal. IO is in pull-up configuration, and waits for an ‘Answer To Reset’ (ATR) 310 generated by the smart card. If the smart card is a UART7816 card, then it will answer an ATR after this sequence.

If the card is a memory card, it may also send an ATR indicating it will communicate on C4 and C8 contacts. During this sequence, the C4 and C8 contacts interface are kept at the same level as 10, which means an open-drain state, with pull-up. This is to avoid having a USB smart card detecting it is being plugged. Indeed, a USB device is detected as inserted as soon as D+/D− are pulled down. If C4(=D+)/C8(=D−) are pulled-up, the smart card won't detect that it is plugged into the socket of physical interface 120.

If the ATR is received at 230, the ISO7816-3 Controller 150 will maintain control and communicate to the full contacts of the physical interface 120. The sequences may be repeated at 240 for the three different classes of cards to communicate with the card to corresponding relevant voltage ranges. Class A corresponds to 5V powered cards, Class B corresponds to 3V powered cards and Class C corresponds to 1.8V powered cards. The sequence is the same, but the level of the signals, generated by the internal power supply 140 follows the 3 classes' rules.

If the ATR is not received at 230, a USB smart card may have been inserted into the socket of physical interface 120. Thus, the card is initially deactivated from the ISO7816-3 activation attempts at 245. Then the USB Host Controller 155 takes control at 250 as directed by processor 160. Control is taken of power supply 140 and physical interface 120 using USB Host logic interface 135.

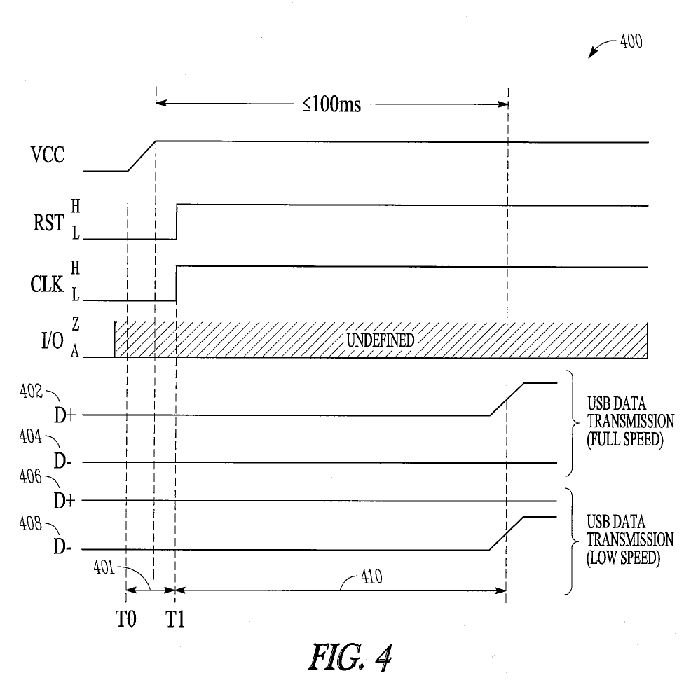

The activation, following the USB standard described in ISO7816-12, is shown in a timing diagram 400 in FIG. 4. The activation may be performed by the smart card 110 at 255, by pulling up D+ or D− during an initial activation period 401, which may be operating at full speed at 402, 404 or a low speed at 406, 408. The activation period 401 provides enough time to the USB smart card to start up, check D+/D− lines, observe they are low, deduce it is plugged to a USB host, and attach itself by pulling up D+ or D− (according to the speed capabilities of the card) during an attachment period 410.

Here, the Vcc is generated whether by Vcc pin of the physical interface (60), or by an external supply, in one embodiment. The D+/D− (eq C4/C8) signals are generated by USB regulator 145 and are high at 3.3V. Then, as the card or device is attaching itself to the host controller 115 of the system, the systems itself may generate a reset signal, and start communicating via that API (such as by asking for descriptors etc. . . . ), and the communication is ready to operate. After these sequences, even if the card is a UART7816 or a USB, the system can indicate the Host controller 115 that the activation sequence is correctly performed and that a card is present and activated inside the smart card socket.

The smart card reader may be connected to a host computer system, or other types of devices such as a microcontroller. A microcontroller may have significant central processing unit power, but may have correspondingly low analogic functionality. Some microcontrollers may lack an analogic interface to communicate with smart cards. The smart card reader may be used to provide such microcontrollers the ability to support both smart card and USB devices like USB smart cards.

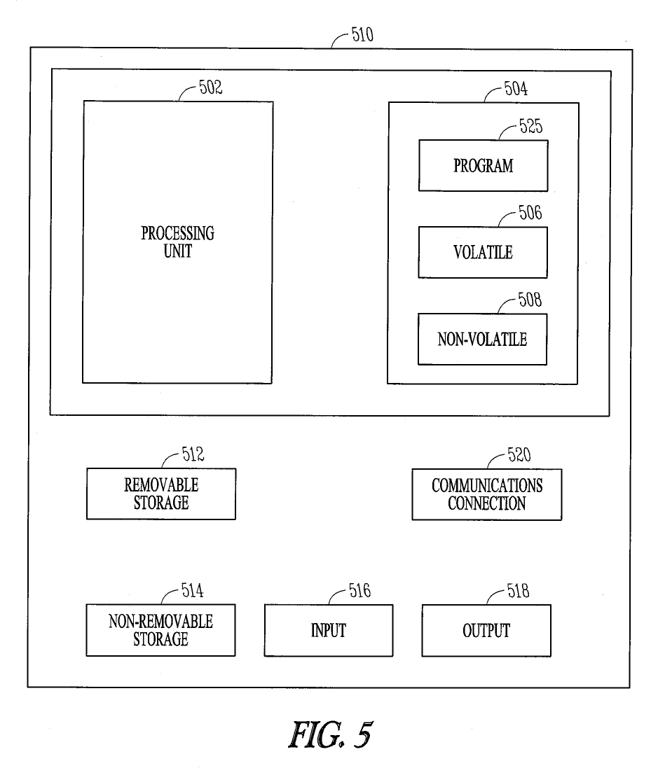

A block diagram of a an example computer system that executes programming for performing functions of the smart card reader and/or the host system is shown in FIG. 5. While a general computing device is shown, the components may be representative of a microcontroller suitable for use in the smart card reader and for the host system that may incorporate or be coupled to the smart card reader. Such a microcontroller in one embodiment, may incorporate only selected elements of FIG. 5. The computer system 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
receiving an indication that a device has been plugged into a socket;
providing power to the socket in accordance with a first type of device;
attempting to communicate with the device in accordance with a first type of device protocol;
if the communication attempt is not successful, providing power to the socket in accordance with a second type of device; and
communicating with the device in accordance with a second type of device protocol without interrupting a host.

2. The method of claim 1 wherein the host is notified once successful communication is established with either the first or second type of device.

3. The method of claim 1 wherein the first type of device protocol utilizes a non-differential voltage and the second type of device protocol utilizes a differential voltage.

4. The method of claim 3 wherein the first type of device protocol utilizes one of several voltages.

5. The method of claim 3 wherein the second type of device protocol has a higher data transfer rate than the first type of device protocol.

6. The method of claim 1 wherein receiving an indication that a device has been plugged into a socket comprises detecting that a presence pin in the socket has been shorted to ground or a predetermined voltage when a card is plugged into the socket.

7. The method of claim 6 and further comprising generating an interrupt in response to the presence pin having been shorted to ground or a predetermined voltage.

8. The method of claim 1 wherein attempting to communicate with the device in accordance with a first type of device protocol comprises generating a reset signal on a reset pin of the socket.

9. The method of claim 8 and further comprising waiting for an ‘Answer To Reset’ (ATR) from a first type of device.

10. A card reader comprising:
a physical interface having a card presence connector;
a logic interface coupled to the physical interface;
a regulator coupled to the logic interface;
a controller coupled to the regulator and to the card presence connector to determine whether a first type of card is coupled to the physical interface and if not, to determine whether a second type of card is coupled to the physical interface; and
a processor coupled to the controller to initiate the controller.

11. The card reader of claim 10 wherein the card reader is coupled to a host and the host is notified once successful communication is established with either the first or second type of card.

12. The card reader of claim 10 wherein the first type of card includes a protocol that utilizes a non-differential voltage and the second type of card includes a protocol that utilizes a differential voltage.

13. The card reader of claim 12 wherein the second type of card protocol has a higher data transfer rate than the first type of card protocol.

14. The card reader of claim 10 wherein the controller generates an interrupt in response to the card presence connector being activated.

15. The card reader of claim 14 wherein the card presence connector is shorted to ground when a card is plugged into the physical interface.

16. The card reader of claim 10 wherein the controller generates a reset signal on a reset pin of the physical interface to attempt to communicate with a plugged in card in accordance with a first type of card protocol.

17. The card reader of claim 16 wherein in the controller waits for an ‘Answer To Reset’ (ATR) from a first type of card.

18. A card reader comprising:
a physical interface having a card presence connector;
a first and a second logic interface coupled to the physical interface;
a power supply coupled to the first logic interface;
a regulator coupled to the second logic interface;
a first controller coupled to the power supply and a second controller coupled to the power supply and the regulator; and
a processor coupled to the first and second controllers and to the card presence connector to initiate the first controller to determine whether a first type of card is coupled to the physical interface and if not, to initiate the second controller to determine whether a second type of card is coupled to the physical interface.

19. The card reader of claim 18 wherein the first type of card includes a protocol that utilizes a non-differential voltage and the second type of card includes a protocol that utilizes a differential voltage.

20. The card reader of claim 18 wherein the processor generates an interrupt in response to the card presence connector being activated.
